(19) United States
(12) Patent Application Publication
(10) Pub. No.: US 2014/0157129 A1
(43) Pub. Date: Jun. 5, 2014

(54) METHODS AND SYSTEMS FOR GESTURE-BASED PETROTECHNICAL APPLICATION CONTROL

(71) Applicants: Afshad E. Dinshaw, Houston, TX (US); Manas M. Kawale, Houston, TX (US); Amit Kumar, Houston, TX (US); Siddharth Palaniappan, Houston, TX (US)

(72) Inventors: Afshad E. Dinshaw, Houston, TX (US); Manas M. Kawale, Houston, TX (US); Amit Kumar, Houston, TX (US); Siddharth Palaniappan, Houston, TX (US)

(73) Assignee: LANDMARK GRAPHICS CORPORATION, Houston, TX (US)

(21) Appl. No.: 14/131,924

(22) PCT Filed: Jun. 25, 2012
(86) PCT No.: PCT/US2012/044027

§ 371 Date: Jan. 10, 2014

Related U.S. Application Data
(60) Provisional application No. 61/535,454, filed on Sep. 16, 2011.
(60) Provisional application No. 61/535,779, filed on Sep. 16, 2011.

(51) Int. Cl. G06F 3/01; G06F 3/0481

(52) U.S. Cl. CPC G06F 3/017; G06F 3/04815
USPC 715/728; 715/771

(57) ABSTRACT

Gesture-based petrotechnical application control. At least some embodiments involve controlling the view of a petrotechnical application by capturing images of a user; creating a skeletal map based on the user in the images; recognizing a gesture based on the skeletal map; and implementing a command based on the recognized gesture.

### CROSS-REFERENCE TO RELATED APPLICATIONS

None

### BACKGROUND

The production of hydrocarbons from underground reservoirs is a complex operation, which includes initial exploration using seismic data, as well as reservoir modeling. In order to increase production from reservoirs, oil and gas companies may also simulate reservoir extraction techniques using the reservoir models, and then implement actual extraction based on the outcomes identified. The ability to visually analyze data increases the extraction of useful information. Such an ability has led to an increase in complexity and accuracy of the reservoir modeling as computer technology has advanced, and as reservoir modeling techniques have improved.

Petrotechnical applications may utilize a three-dimensional (3D) view of a physical space to display seismic or reservoir models to a user. A user interacts with and manipulates the 3D view through the use of input devices such as a mouse and a keyboard. However, using these input devices is not intuitive for the user when interacting with the application. Thus, any invention which makes interaction with a petrotechnical application more intuitive and streamlined would be beneficial.

### BRIEF DESCRIPTION OF THE DRAWINGS

For a detailed description of exemplary embodiments, reference will now be made to the accompanying drawings in which:

FIG. 1 shows an exemplary user interaction with an application in accordance with some embodiments.

FIG. 2 shows an exemplary user interaction with an application in accordance with some embodiments.

FIG. 3 shows an exemplary user interaction with an application in accordance with some embodiments.

FIG. 4 shows an exemplary user interaction with an application in accordance with some embodiments.

FIG. 5 shows a skeletal mapping of a user hand in accordance with some embodiments.

FIG. 6 shows, in block diagram, a hardware system in accordance with some embodiments.

FIG. 7 shows, in block diagram form, the relationship between hardware and software in accordance with some embodiments.

FIG. 8 shows, in block diagram form, a computer system in accordance with some embodiments.

FIG. 9 shows, in block flow diagram form, a method in accordance with at least some embodiments.

### NOTATION AND NOMENCLATURE

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device that connection may be through a direct connection or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to control of an interactive petrotechnical application where the control is provided through physical movements, or gestures, of a user interacting with the application. In addition to physical gestures, the interactive application may also be controlled by a combination of physical gestures and/or audio commands. The specification first turns to a high level overview of control of petrotechnical applications, and then turns to specifics on the implementation of such control.

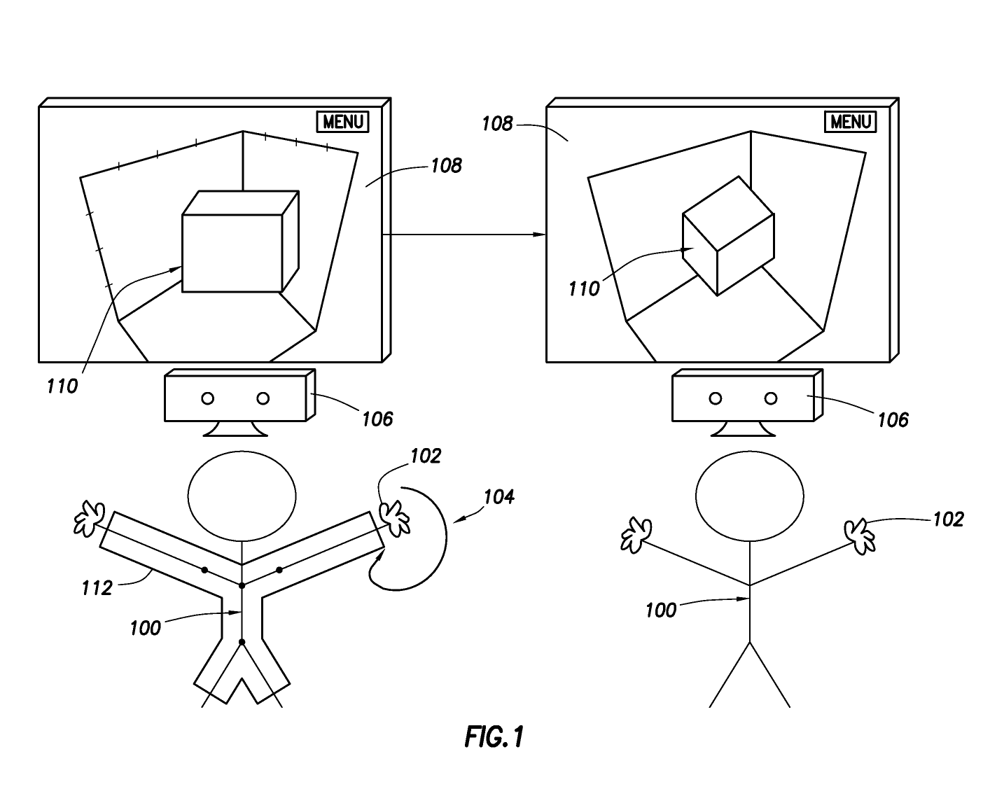

FIG. 1 shows an interactive petrotechnical application 108 controlled by user gestures. User 112 interacts with a three-dimensional representation 110 projected onto a two-dimensional display of application 108. In one embodiment, the representation 110 may be a three-dimensional representation of a geologic model of a hydrocarbon bearing formation projected onto a two-dimensional display. In another embodiment, the representation 110 may be a three-dimensional representation of a hydrocarbon bearing formation created based on seismic data and projected onto a two-dimensional display. In various embodiments, when a user stands (or sits) in front of the application 108 display and system 106, system 106 captures images of user 112 and associates the images with a skeletal map, such as skeletal map 100. Based on the illustrative skeletal map 100, system 106 tracks changes in the positioning of the body by tracking identified skeletal joints of interest, and then subsequently determines what gesture user 112 is making from the tracked movement (e.g., shape, speed, magnitude). System 106 implements a command associated with the recognized gesture, the command implemented within the application 108. For example, user 112 may interact with representation 110 by commanding the application 108 to change the view of the representation 110 by making the related gestures with his body, such as to: rotate the view of the model; zoom in or out; pan left or right; or make alterations, additions or deletions to the model.

In the specific example of FIG. 1, user 112 makes a circular gesture 104 with hand 102. System 106 captures images of the user and feeds it to system and associates the user images with a corresponding skeletal map 100. The system may associate a recognized circular gesture 104 as corresponding to the application 108 command to rotate the representation 110 around its y-axis such that user 112 can view the representation from another angle. Thus, when user 112 makes a circular gesture 104, system 106 recognizes the movements associated with the skeletal map 100, and translates the gesture movement to the specific command to rotate the representation 110. In the second frame of FIG. 1, the interactive application 108 has responded to the gesture by showing the representation 110 as rotated. The circular gesture 104 made by user 112 resulting in a rotation of the three-dimensional representation 110 around its y-axis is one example of what a recognized gesture may do, however a circular gesture is not limited solely to a rotation type command.

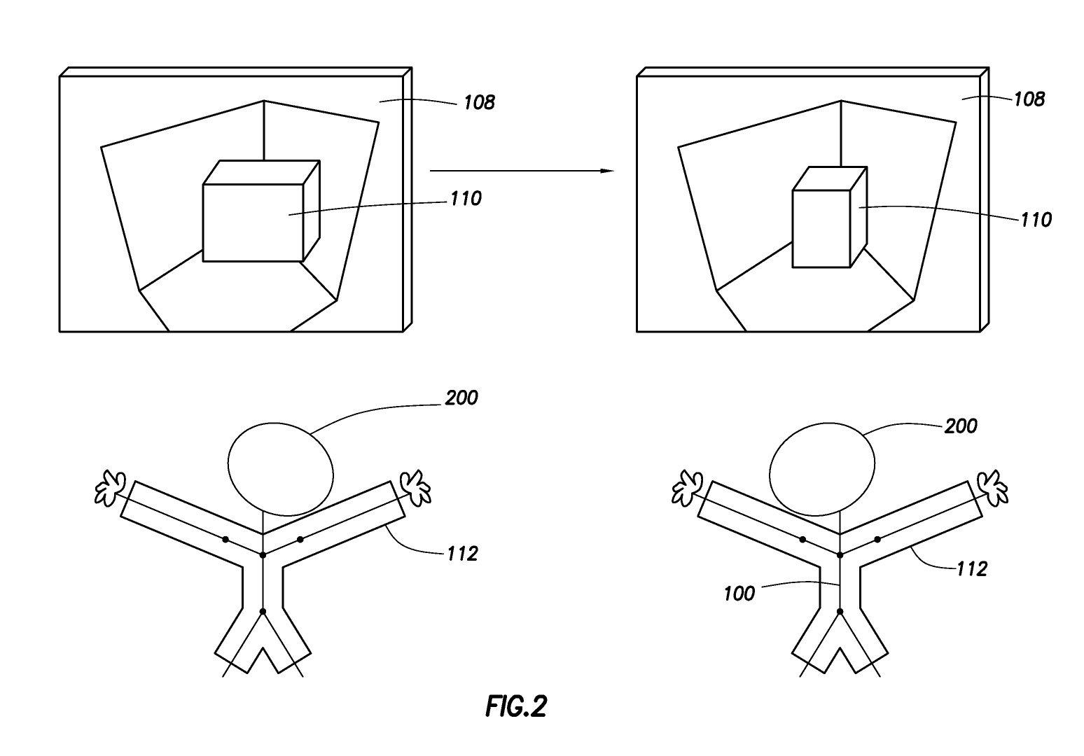

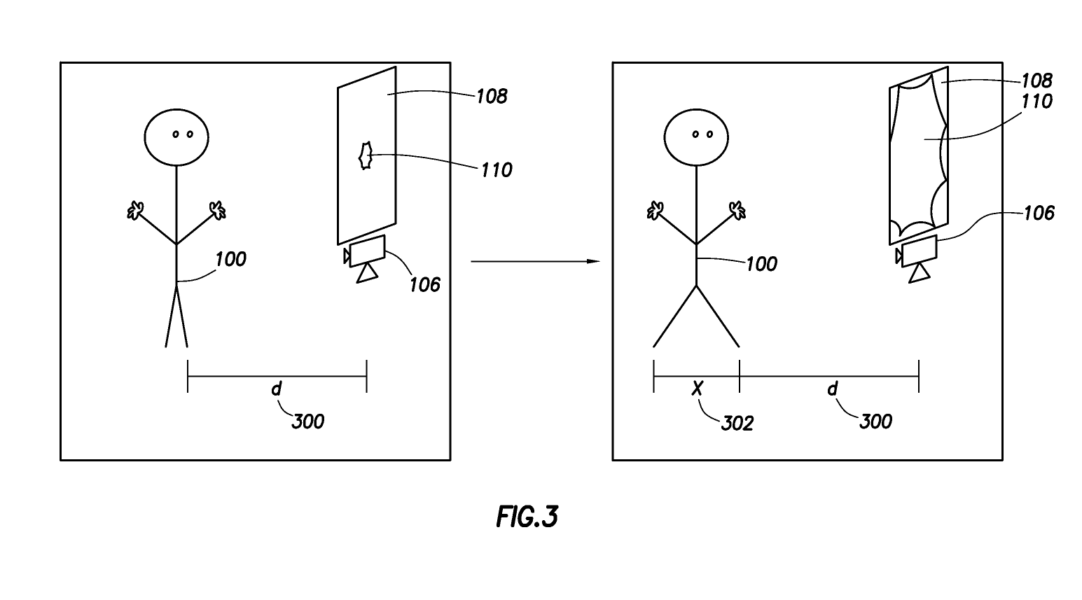

FIG. 2 shows another embodiment of controlling a petrotechnical application through the use of gestures. In particular, FIG. 2 illustrates a gesture represented by the movement of the head 200 of user 112 to control the view presented by the application 108. In this example, if user 112 tilts his head to the right (as shown on the left portion of FIG. 2), the view of representation 110 will respond correspondingly, such as by changing the angle as if the user were looking around the right side of the three-dimensional representation. Likewise, if the user tilts his head to the left (as shown on right portion of FIG. 2), the view of the object will change correspondingly. The head tilting gesture made by user 112 resulting in changing the view of representation 110 is one example of what a recognized gesture may do, however a head tilt gesture is not limited solely to a change-of-view command.

FIG. 3 shows yet another embodiment of controlling a petrotechnical application through the use of gestures. In particular, FIG. 3 illustrates a gesture in the form of a change in distance of the user from the application 108 display. A user may gesture by physically moving nearer to or farther from the system 106 to command the application 108 to change the zoom level on the representation 110. For example, in FIG. 3, user 112 is standing distance ‘d’ 300 from the application 108 display. By moving towards the screen a distance ‘x’ 302, the view of representation 110 is “zoomed in” by an amount proportional to the distance traveled (e.g., a ratio of zoom-percentage-to-distance-traveled). If user 112 steps farther forward, the view of object will zoom in farther. If user 112 steps backwards, the view will zoom out (e.g., based on the programmed ratio between distance traveled and zoom level). The gesture made by user 112 of moving closer to and farther from application 108 display resulting in changing the zoom of representation 110 is one example of what a recognized gesture may do, however a gesture of moving a distance towards or away from the application 108 display is not limited solely to zooming into or out from an application.

As described above, but not limited solely to the commands described above, a user's gestures may directly manipulate a representation 110 or application 108 view based on gestures. Additionally, a user's gestures may specifically correspond to menu manipulation, such as opening files, sharing files, or saving files. Furthermore, in some embodiments, more than one user may control the application through the use of gesture-based commands.

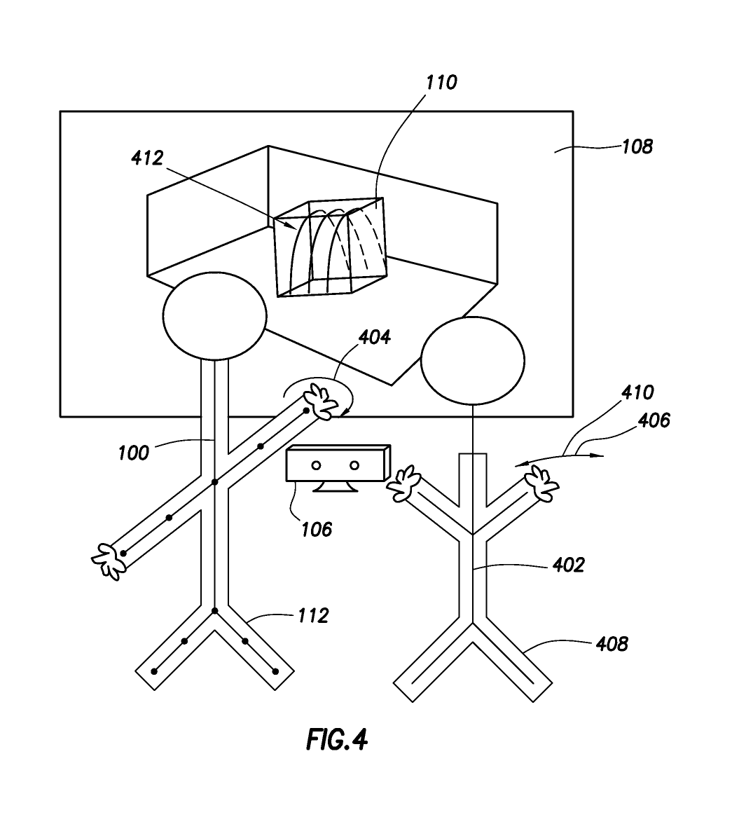

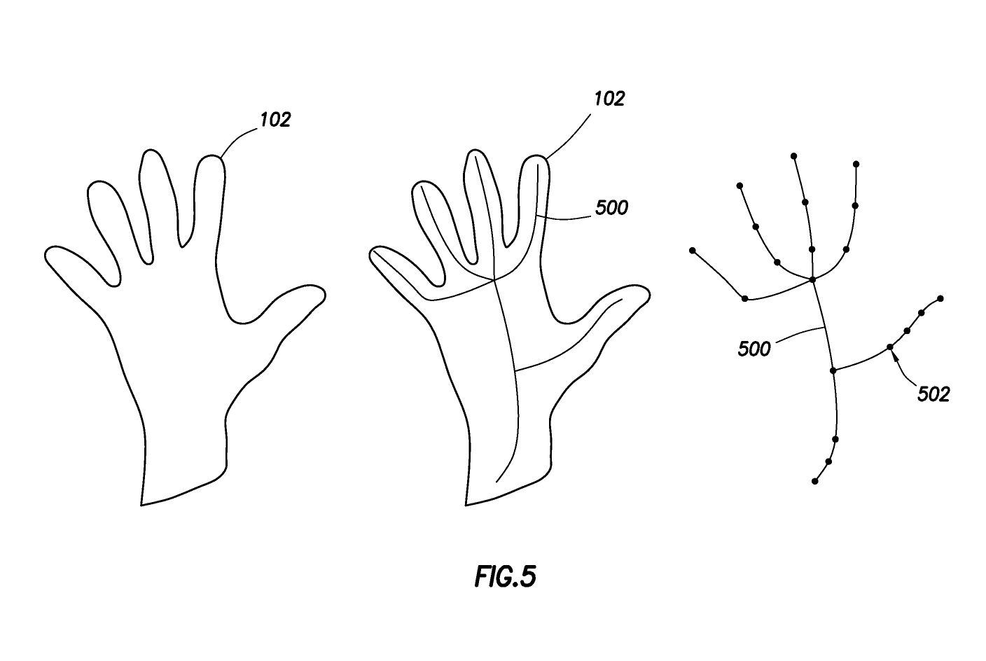

FIG. 4 shows two users interacting with application 108 through the use of collaborative gestures. In particular, FIG. 4 shows user 112 and user 408 are interacting with the application 108 collaboratively. With regard to user 408, system 106 further creates a second skeletal map based on the user 408 in the images captured and recognizes a gesture based on the second skeletal map of user 408 to create a second recognized gesture. The system implements a command based on the gestures of user 112 by adding to or modifying an object in the three-dimensional representation 110, and then implements a command based on the recognized gesture of user 408, modifying the object in the three-dimensional representation 110. For example, user 112 makes gesture 404 to “draw” seismic lines 412 onto a seismic volume, as shown by representation 110 on the application 108 display. User 408 may then modify the placement of the seismic lines 412 drawn by making gesture 406 to select the desired seismic lines 412 and then making gesture 410 to move the seismic lines 412 to an alternate location. System 106 recognizes the gestures of both users and implements the commands based on the gestures recognized. The gestures made by users 112 and 408 to draw and modify seismic lines on a seismic volume are one example of how collaborative gestures affect an application, however two or more users interacting with an application are not limited solely to such an interaction.

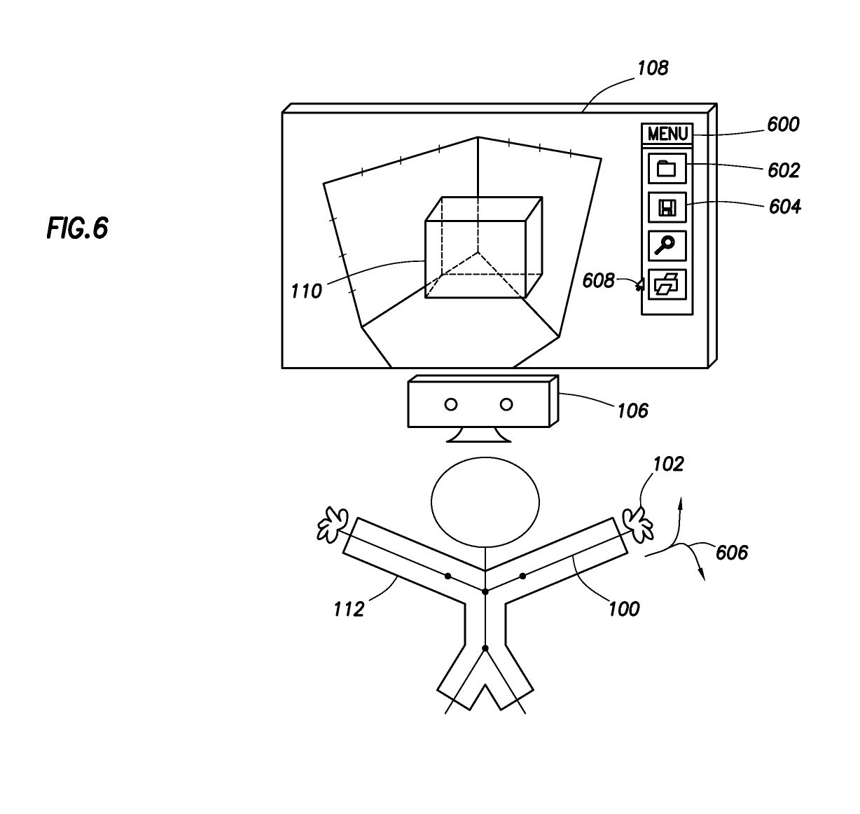

While skeletal mapping and skeletal joint identification may encompass the entire body, skeletal maps can also be created for smaller, select portions of the body, such as a user's hand. Turning now to FIG. 5, in some embodiments system 106 creates a skeletal map of a user's hand. In particular, the left most image of FIG. 5 shows the image of a hand, such hand 102 of user 112, captured by the system 105. The middle image of FIG. 6 shows the image of hand 102 overlaid with a representation of a corresponding skeletal map 500 created by the system 106. In the right most image of FIG. 5, skeletal map 500 is shown with individual skeletal joints, such as thumb joint 502. When user 112 gestures using the hand, the system 106 may recognize the gesture and implement a corresponding command. For example, by moving his thumb a user may gesture the command for “clicking” to select a menu item, where the system 106 captures the movement of skeletal joint 502, recognizes the movement as a recognized gesture corresponding to, for example, “clicking” to select a menu item (as described in more detail below) In another embodiment, user 112 may make a “swiping” movement with hand 102 to gesture the command for panning the view of the application. In yet another embodiment, user 112 may make a first with hand 102 indicating a gesture to close out the current view of the application. In another embodiment, hand gestures may also be used to control menus associated with the application.

Turning to FIG. 6, FIG. 6 shows another embodiment of controlling a menu associated with, and displayed as part of, a petrotechnical application, through the use of gestures. In particular, FIG. 6 illustrates a gesture 606 to control menu 600. In this example, user 112 makes a gesture 606 to interact with menu 600. Like other gestures described previously, menu-control specific gestures can be preprogrammed. In one embodiment, user 112 may make a gesture to bring up a cursor within the application 108. User 112 may then move his hand 102, controlling the path of the cursor over the “menu” icon 600, and make a “clicking” gesture 606, as by clicking a physical mouse button. The “clicking” gesture 606 may correspond to activating menu 600, the activation of which may provide additional menu options. User 112 may move his hand 102, moving cursor 608 within the application 108 view, as to select and activate more menu options, such as menu options “open”, represented by icon 602 and “save”, represented by icon 604. While “clicking” to open a menu, as well as “clicking” to activate other menu options, are some examples of what recognized gestures may do, the “clicking” gesture is not limited solely to a menu control command, nor are menus controlled solely by the described example gestures.

As discussed so far, physical gestures made by one or more users are recognized by the system 106 to implement commands based on the recognized gestures. However, it is also possible that audio commands combined with physical gestures, or independently, may be used to issue commands to the application 108. In particular, the system 106 may receive both video and audio data corresponding to a user controlling the application 108 by way of physical and audio gesturing. For example, in one embodiment, an application may be controlled by the user gesturing with his right hand. Wanting to switch control of the application to the other hand, the user issues the command to change hands by clapping his hands together. The system recognizes the audio sound of two hands being clapped together as a command, as well as recognizes the physical gesture of the clap, to change control of the handedness of the application. While this example embodiment combines both physical and audio gestures, commands may be executed by physical gestures alone, audio gestures alone, or a combination of physical and audio gestures.

In another embodiment, the combination of physical and audio gestures may aid in more precise command implementations. For example, user 112 may desire to rotate the three-dimensional representation 110 exactly 43 degrees around the x-axis. A hand gesture itself may not be able to accurately gesture for 43 degrees of movement; however in conjunction with the physical gesture, user 112 may issue a verbal command to stop the rotation after 43 degrees. In yet another embodiment, two users interacting with the application may do so in such a way where one user commands using physical gestures, and the second user modifies or adds to the first user's commands by issuing verbal commands. The audio gestures described above, either alone or combined with physical gestures, are examples audio gesture-based commands, however audio gestures are not limited solely to such interactions.

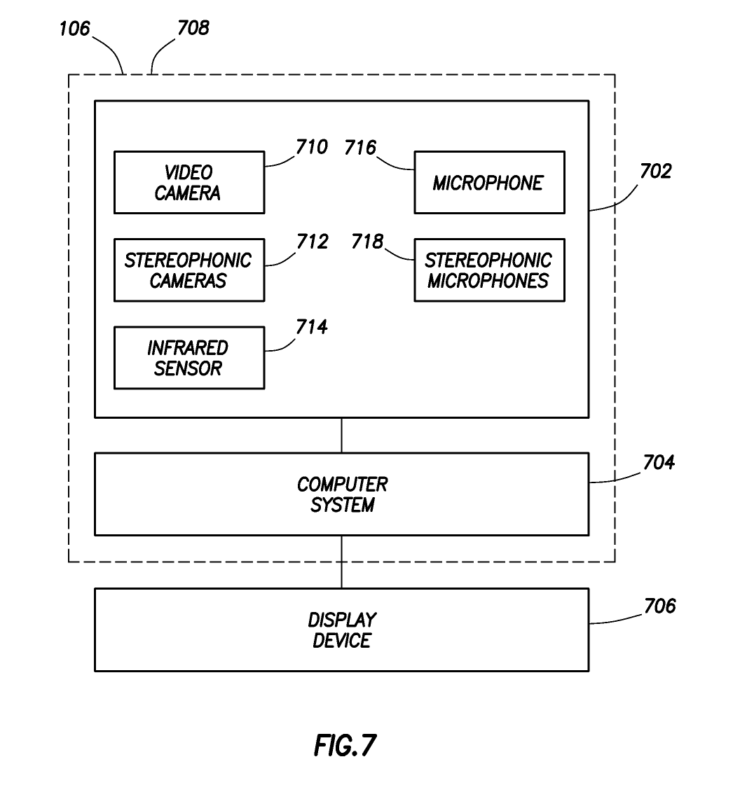

The specification now turns to a more detailed description of system 106. The system 106 may be a collection of hardware elements, combined with software elements, which work together to capture images of the user, create a skeletal map, associate a recognized gesture (visual and/or audio) with a specific command, and execute the command within an application. FIG. 7 shows, in block diagram form, hardware components of the system 106 in accordance with various embodiments. In particular, FIG. 7 shows a sensor device 702, a computer system 704, and a display device 706.

Turning first to the capture of image and audio data related to a user, sensor device 702 may comprise a plurality of components used in capturing images and audio related to the user. The sensor device 702 may be configured to capture image data of the user using any of a variety of video input options. In one embodiment, image data may be captured by one or more color or black and white video cameras 710. In another embodiment, image data may be captured through the use of two or more physically separated stereoscopic cameras 712 viewing the user from different angles in order to capture depth information. In yet another embodiment, image data may be captured by an infrared sensor 714 detecting infrared light. Audio may be captured by microphone 716 or by two or more stereophonic microphones 718. In one embodiment, sensor device 702 may comprise one or more cameras and/or microphones; however, in other embodiments, the video and/or audio capture devices may be externally coupled to the sensor device 702 and/or the computer system 704.

Sensor device 702 may couple to computer system 704 through a wired connection such as a Universal Serial Bus (USB) connection or a Firewire connection, or may couple to computer system 704 by way of a wireless connection. In one embodiment, computer system 704 may be a stand-alone computer, while in other embodiments computer system 704 may be a group of networked computers. In yet another embodiment, sensor device 702 and computer system 604 may comprise an integrated device 708 (e.g., laptop, notebook, tablet or smartphone with sensor devices in the lid). Sensor device 702 and computer system 704 couple to display device 706. In one embodiment, display device 706 may be a monitor (e.g., a liquid crystal display, a plasma monitor, or a cathode ray tube monitor). In other embodiments, display device 706 may be a projector apparatus which projects the application onto a two-dimensional surface. The specification now turns to a more detail description of the software of system 106 as shown in FIG. 7, which illustrates a representation of various software components which may work together to implement various embodiments in conjunction with sensor device 702 and computer system 704.

Computer Software

Computer system 704 may comprise a plurality of software components, including one or more skeletal tracking application programming interfaces (APIs) 802, skeletal toolkit software 804, gesture-based application control software 806, and software libraries 808. Each will be discussed in turn.

Skeletal tracking API 802 is a software library of functions which focuses on real-time image processing and provides support for sensor device 702 in capturing and tracking body motions, as well as providing support for audio data capture (e.g., open source API OpenCV developed by Intel® or OpenNI available from the OpenNI Organization). As previously discussed, sensor device 702 captures images of a user. API 802 then creates an associated skeletal map and tracks skeletal joint movement, which may correspond to a gesture to control an application. Skeletal toolkit 804 (e.g., Flexible Action and Articulated Skeleton Toolkit, or FAAST, developed by the Institute of Creative Technologies at the University of California), which facilitates the integration of gesture-based application control using skeletal map and skeletal joint tracking may interact with skeletal tracking API 802. In another embodiment, skeletal tool kit 804 need not interact with a skeletal tracking API 802, but rather with other gesture-based application control software 806, to analyze and associate gestures with commands to control a petrotechnical application. When API 802 analyzes skeletal joint movement, it compares the movement with a library of recognized gestures. If the movement matches that of a recognized gesture, system 106 implements the associated command within the application. While a pre-defined library of recognized skeletal joint gestures may exist (such as gesture recognition library 818 within the gesture based application control software 806 818), the skeletal toolkit may allow a user to add new recognized skeletal joint gesture and application control pairings.

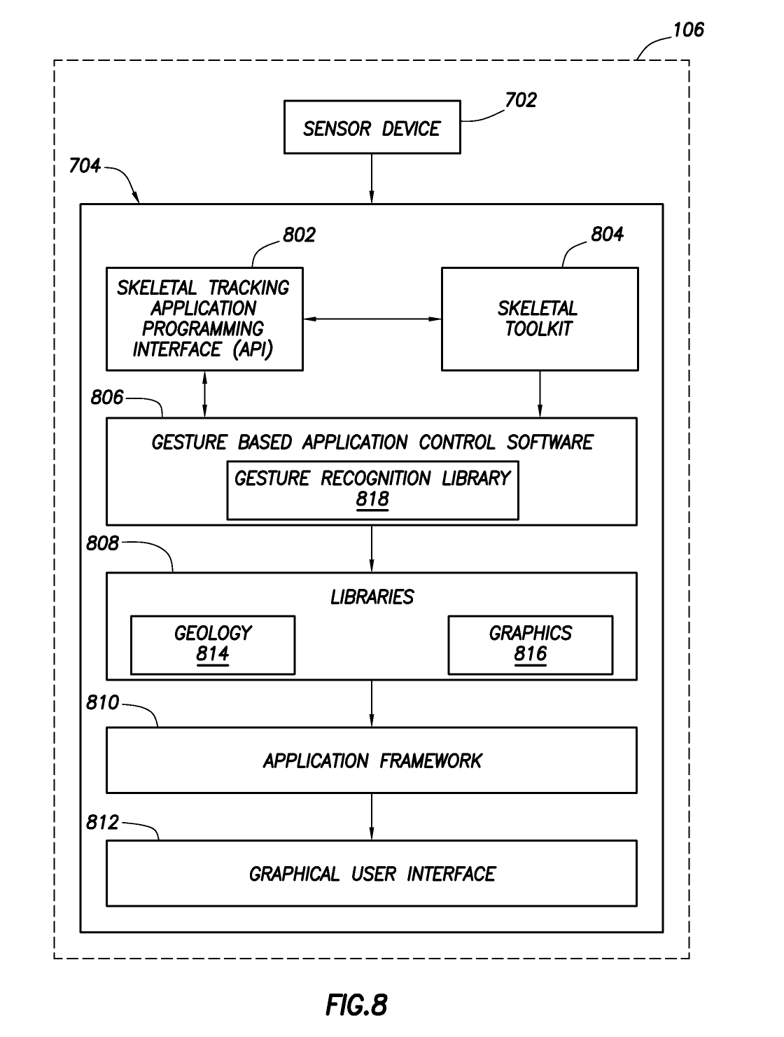

In conjunction with the other software, software libraries 808 may provide additional support in capturing images, recognizing gestures, and implementing commands on the application. Three example libraries are shown in FIG. 8, but any number or type of library may be used. In FIG. 8, geology library 814 provides support in the simulation of certain geophysical and geological data, such geologic formations and scenarios. Graphics library 816 may aid in the support of rendering shapes and text information.

While a stand-alone system has been described in the specification thus far, similar functionality may be implemented by incorporating a plug-in module into existing stand-alone petrotechnical application software. More specifically, separate software executing capturing images, creating skeletal maps, tracking skeletal joint movements, recognizing gestures, and implementing gesture-based commands may be added to pre-existing application control software running on the same or a separate hardware system.

### EXAMPLE COMPUTING ENVIRONMENT

The various embodiments discussed to this point operate in conjunction with computer systems of varying forms. For example, computer system 704 may be a desktop or laptop computer system, or may be integrated with a sensor device 702 into a single system.

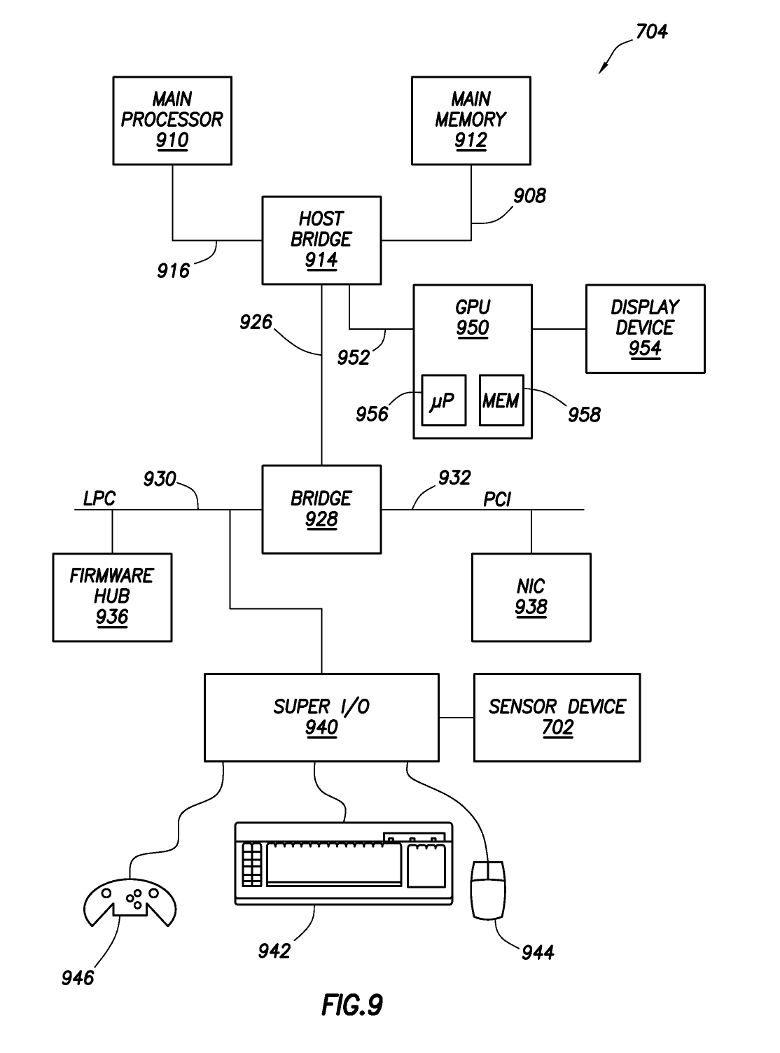

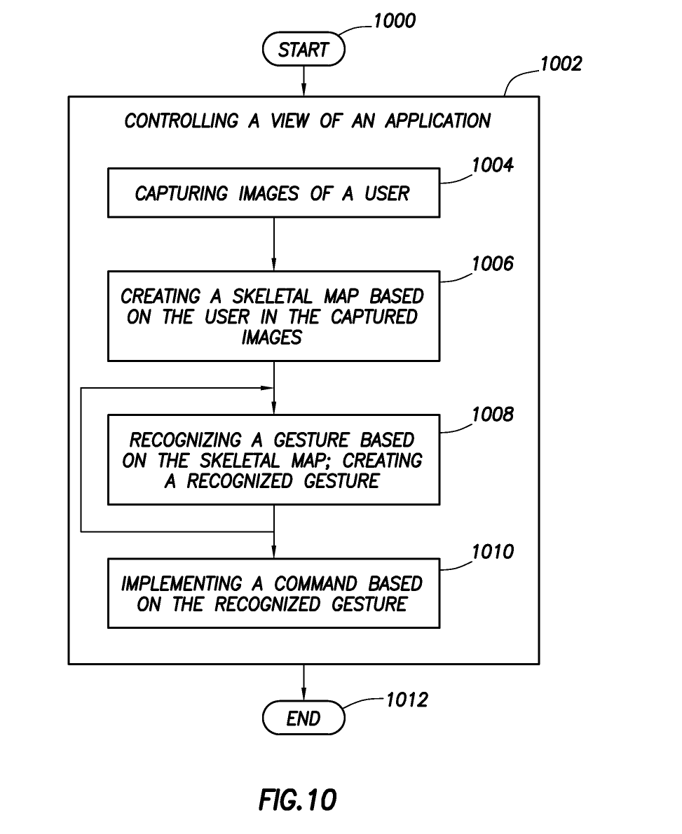

FIG. 9 illustrates a computer system 704 in accordance with at least some embodiments. Any of all of the embodiments that involve capturing user images, creating skeletal maps, tracking skeletal joint movement, recognizing gestures, and implementing gesture-command pairings within an interactive application may be implemented in whole or in part on a computer system such as that shown in FIG. 9, or after-developed computer systems. In particular, computer system 704 comprises a main processor 910 coupled to a main memory array 912, and various other peripheral computer system components, through integrated host bridge 914. The main processor 910 may be a single processor core device, or a processor implementing multiple processor cores. Furthermore, computer system 704 may implement multiple main processors 910. The main processor 910 couples to the host bridge 914 by way of a host bus 916, or the host bridge 914 may be integrated into the main processor 910. Thus, the computer system 704 may implement other bus configurations or bus-bridges in addition to, or in place of, those shown in FIG. 9.

The main memory 912 couples to the host bridge 914 through a memory bus 918. Thus, the host bridge 914 comprises a memory control unit that controls transactions to the main memory 912 by asserting control signals for memory accesses. In other embodiments, the main processor 910 directly implements a memory control unit, and the main memory 912 may couple directly to the main processor 910. The main memory 912 functions as the working memory for the main processor 910 and comprises a memory device or array of memory devices in which programs, instructions and data are stored. The main memory 912 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM). The main memory 912 is an example of a non-transitory computer-readable medium storing programs and instructions, and other examples are disk drives and flash memory devices.

The illustrative computer system 704 also comprises a second bridge 828 that bridges the primary expansion bus 926 to various secondary expansion buses, such as a low pin count (LPC) bus 930 and peripheral components interconnect (PCI) bus 932. Various other secondary expansion buses may be supported by the bridge device 928.

Firmware hub 936 couples to the bridge device 928 by way of the LPC bus 930. The firmware hub 936 comprises read-only memory (ROM) which contains software programs executable by the main processor 910. The software programs comprise programs executed during and just after power on self test (POST) procedures as well as memory reference code. The POST procedures and memory reference code perform various functions within the computer system before control of the computer system is turned over to the operating system. The computer system 604 further comprises a network interface card (NIC) 938 illustratively coupled to the PCI bus 932. The NIC 938 acts to couple the computer system 704 to a communication network, such the Internet, or local- or wide-area networks.

Still referring to FIG. 9, computer system 704 may further comprise a super input/output (I/O) controller 940 coupled to the bridge 928 by way of the LPC bus 930. The Super I/O controller 940 controls many computer system functions, for example interfacing with various input and output devices such as a keyboard 942, a pointing device 944 (e.g., mouse), a pointing device in the form of a game controller 946, various serial ports, floppy drives and disk drives. The super I/O controller 940 is often referred to as “super” because of the many I/O functions it performs.

The computer system 704 may further comprise a graphics processing unit (GPU) 950 coupled to the host bridge 914 by way of bus 952, such as a PCI Express (PCI-E) bus or Advanced Graphics Processing (AGP) bus. Other bus systems, including after-developed bus systems, may be equivalently used. Moreover, the graphics processing unit 950 may alternatively couple to the primary expansion bus 926, or one of the secondary expansion buses (e.g., PCI bus 932). The graphics processing unit 950 couples to a display device 954 which may comprise any suitable electronic display device upon which any image or text can be plotted and/or displayed. The graphics processing unit 950 may comprise an onboard processor 856, as well as onboard memory 958. The processor 956 may thus perform graphics processing, as commanded by the main processor 910. Moreover, the memory 958 may be significant, on the order of several hundred megabytes or more. Thus, once commanded by the main processor 910, the graphics processing unit 950 may perform significant calculations regarding graphics to be displayed on the display device, and ultimately display such graphics, without further input or assistance of the main processor 910.

The method of controlling an interactive application through the use of gestures will now be discussed in more detail. FIG. 10 shows a flow diagram depicting an overall method of using gestures to control an application according to a sample embodiment. The method starts (block 1000), and moves to controlling a view of an application (block 1002). Controlling a view of an application starts with capturing images of a user (block 1004). A skeletal map is created based on the user captured in the images (block 1006). If the user makes a gesture, the gesture is recognized based on the skeletal map created in block 1004 (block 1008). If the recognized gesture from block 1004 is one that corresponds to a command, the command is implemented based on the recognized gesture (block 1010). Thereafter, the method ends (block 1012).

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments, and/or to create a non-transitory computer-readable storage medium (i.e., other than an signal traveling along a conductor or carrier wave) for storing a software program to implement the method aspects of the various embodiments.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment.

The above discussion is meant to be illustrative of the principles and various embodiments of the present invention. Numerous variations and modifications will become apparent to those skilled in the art once the above disclosure is fully appreciated. For example, while the various software components have been described in terms of the gesture-based control of petrotechnical applications, the development context shall not be read as a limitation as to the scope of the one or more inventions described—the same techniques may be equivalently used for other gesture-based analysis and implementations. It is intended that the following claims be interpreted to embrace all such variations and modifications.

What is claimed is:

1. A method comprising:
controlling a view of a petrotechnical application by:
capturing images comprising a first user;
creating a first skeletal map based on the first user in the images;
recognizing a gesture based on the first skeletal map to create a first recognized gesture; and
implementing a command based on the first recognized gesture.

2. The method of claim 1:
wherein recognizing further comprises recognizing a change of head position of the first user to be the first recognized gesture; and
wherein implementing further comprises changing the view of the petrotechnical application.

3. The method of claim 1:
wherein recognizing further comprises recognizing a change of distance of the first user from a camera to be the first recognized gesture; and
wherein implementing further comprises changing the zoom level of the petrotechnical application.

4. The method of claim 1 wherein recognizing the gesture further comprises:
training the system to recognize a first gesture, where the first gesture is previously unrecognized; and then
recognizing the first gesture as the first recognized gesture.

5. The method of claim 1 wherein creating a first skeletal map further comprises:
creating a first skeletal map of a hand of the first user; and then
recognizing a gesture involving the first skeletal map of the hand of the first user.

6. The method of claim 1 further comprising:
creating a second skeletal map based on a second user in the images;
recognizing a gesture based on the second skeletal map to create a second recognized gesture;
wherein implementing further comprises adding or modifying an object in a three-dimensional representation in the view; and
implementing a command based on the second recognized gesture and thereby modifying the object in the three-dimensional representation in the view.

7. The method of claim 1:
wherein recognizing further comprises recognizing a clapping of two hands together; and
wherein implementing further comprises changing control of the petrotechnical application to a different hand.

8. The method of claim 7 wherein the method further comprises verifying the clapping of two hands together based on an audible sound received by at least one microphone.

9. The method of claim 1 wherein the method further comprises:
recognizing an audible sound received by at least one microphone related to the first recognized gesture;
implementing the command based on the audible sound.

10. The method of claim 1 wherein recognizing further comprises determining a distance moved by calculating movement between or one more video cameras.

11. A computer system comprising:
a processor;
a memory coupled to the processor;
a display device coupled to the processor;
the memory storing a program that, when executed by the processor, causes the processor to:
capture images comprising a first user by way of a camera operatively coupled to the processor;
create a first skeletal map based on the first user in the images;
recognize a gesture based on the first skeletal map to create a first recognized gesture;
implement a command based on the first recognized gesture; and thereby
change a three-dimensional representation of an earth formation shown on the display device.

12. The computer system of claim 11:
wherein when the processor recognizes, the program further causes the processor to recognize a change of head position of the first user to be the first recognized gesture; and
wherein when the processor implements, the program further causes the processor to change the view of the three-dimensional earth formation shown on the display device.

13. The computer system of claim 11 further comprising:
a camera system coupled to the processor;
wherein when the processor recognizes, the program further causes the processor to recognize a change of distance of the first user from the camera to be the first recognized gesture; and
wherein when the processor implements, the program further causes the processor to change the zoom level of the three-dimensional earth formation shown on the display device.

14. The computer system of claim 13 further comprising at least one selected from the group of: stereoscopic cameras; black and white camera; color camera; and infrared sensor.

15. The computer system of claim 11 wherein when the processor recognizes the gesture, the program further causes the processor to:
train the system to recognize a first gesture, where the first gesture is previously unrecognized; and then
recognize the first gesture as the first recognized gesture.

16. The computer system of claim 11 wherein when the processor creates a first skeletal map, the program further causes the processor to:
create a first skeletal map of a hand of the first user; and then
recognize a gesture involving the first skeletal map of the hand of the first user.

17. The computer system of claim 11 wherein the program causes the processor to:
create a second skeletal map based on a second user in the images;
recognize a gesture based on the second skeletal map to create a second recognized gesture;
wherein when the processor implements, the program further causes the processor to implement adding or modifying an object in the three-dimensional representation shown on the display device; and
implement a command based on the second recognized gesture and thereby modifying the object in the three-dimensional earth formation shown on the display device.

18. The computer system of claim 11 further comprising:
a microphone coupled to the processor;
wherein when the processor recognizes, the program further causes the processor to recognize a clapping of two hands together based on sound received by the microphone; and
wherein implementing further comprises changing control of the view of the three-dimensional earth formation shown on the display device.

19. The computer system of claim 18 wherein the program further causes the processor to verify the clapping of two hands together based on an audible sound.

20. The computer system of claim 11 wherein the program further causes the processor to:
recognize an audible sound related to the first recognized gesture; and
implement the command based on the audible sound.

21. A non-transitory computer-readable medium storing instructions that, when executed by a processor, causes the processor to:
control a view of a petrotechnical application by causing the processor to:
capture images comprising a first user;
create a first skeletal map based on the first user in the images;
recognize a gesture based on the first skeletal map to create a first recognized gesture;
implement a command based on the first recognized gesture.

22. The non-transitory computer-readable medium of claim 21:
wherein when processor recognizes, the instructions further cause the processor to recognize a change of head position of the first user to be the first recognized gesture; and
wherein when the processor implements, the instructions further cause the processor to change the view of the petrotechnical application.

23. The non-transitory computer-readable medium of claim 21:
wherein when processor recognizes, the instructions further cause the processor to recognize a change of distance of the first user from the camera to be the first recognized gesture
wherein when the processor implements, the instructions further cause the processor to change the zoom level of the petrotechnical application.

24. The non-transitory computer-readable medium of claim 21 wherein the instructions further cause the processor to:
train the system to recognize a first gesture, where the first gesture is previously unrecognized; and then
recognize the first gesture as the first recognized gesture.

25. The non-transitory computer-readable medium of claim 21:
wherein when the processor creates, the instructions further cause the processor to create the first skeletal map of a hand of the first user; and then
wherein when the processor recognizes, the instructions further cause the processor to recognize a gesture involving the first skeletal map of the hand of the first user.

26. The non-transitory computer-readable medium of claim 21 wherein the instructions further cause the processor to:
create a second skeletal map based on a second user in the images;
recognize a gesture based on the second skeletal map to create a second recognized gesture;
wherein when the processor implements, the program further causes the processor to implement adding or modifying an object in a three-dimensional representation; and
implement a command based on the second recognized gesture and thereby modifying the object in the three-dimensional representation.

27. The non-transitory computer-readable medium of claim 21:
wherein when processor recognizes, the instructions further cause the processor to recognize a clapping of two hands together; and
wherein when the processor implements, the instructions further cause the processor to change control of the petrotechnical application to a different hand.

28. The non-transitory computer-readable medium of claim 21 wherein the instructions further cause the processor to verify the clapping of two hands together based on an audible sound.

29. The non-transitory computer-readable medium of claim 21 wherein the instructions further cause the processor to:
recognize an audible sound related to the first recognized gesture;
implement the command based on the audible sound.

30. The non-transitory computer-readable medium of claim 21 wherein the instructions further cause the processor to capture infrared frequencies.
